(19) United States
(12) Patent Application Publication
(10) Pub. No.: US 2018/0185822 A1
(43) Pub. Date: Jul. 5, 2018

(54) CATALYST CARRIER AND METHODS OF FORMING THEREOF

(71) Applicant: Saint-Gobain Ceramics & Plastics, Inc., Worcester, MA (US)

(72) Inventors: Nabil NAHAS, Waltham, MA (US); Ian Victor KIDD, Worcester, MA (US)

(21) Appl. No.: 15/838,454

(22) Filed: Dec. 12, 2017

Related U.S. Application Data
(60) Provisional application No. 62/439,988, filed on Dec. 29, 2016.

(51) Int. Cl. B01J 21/04; B01J 23/10; C01F 17/00; C01F 11/02

(52) U.S. Cl. CPC B01J 21/04; B01J 23/10; C01P 2002/72; C01F 11/02; C01F 17/0025

(57) ABSTRACT

A catalyst carrier may include an aluminate based body and may have a specific surface area of not greater than about 20 m²/g. The aluminate based body may include a hexaaluminate phase.

### CROSS-REFERENCE TO RELATED APPLICATION

This application claims the benefit of U.S. Provisional Application No. 62/439,988 filed Dec. 29, 2016.

### FIELD OF THE INVENTION

The following is directed generally to catalyst carriers, and more particularly to aluminate based catalyst carriers and methods of making the same.

### BACKGROUND

Porous ceramic particles may be used in a wide variety of applications and, in particular, are uniquely suited to serve, for example, in the catalytic field as a catalysts, catalyst carriers or component of catalyst carriers. The production and use of thermally stable catalysts, catalyst carriers and components of catalyst carriers is desirable for their use in environmental applications as well as the chemical industry, often in fixed bed catalytic reactors. Aluminate based materials containing elements with various redox levels (i.e., Mn, Fe, etc.) are generally desirable for such catalyst based applications due to the material's thermal and reactivity characteristics. Accordingly, the industry continues to demand improved aluminate based porous ceramic particles having various desired chemical qualities, such as, known reactivity and high stability, in combination with desired physical qualities, such as, a set porosity and surface area and desired mechanical properties.

### SUMMARY

According to a first aspect, a catalyst carrier may include an aluminate based body and may have a specific surface area of not greater than about 20 m²/g. The aluminate based body may include a hexaaluminate phase.

According to yet another aspect, a method of forming a catalyst carrier may include providing an aluminate precursor mixture, forming the aluminate precursor mixture into a green carrier and heating the aluminate precursor mixture to form the catalyst carrier. The catalyst carrier may include a hexaaluminate phase and formation of the hexaaluminate phase may occur in-situ during heating of the aluminate precursor mixture.

According to still another aspect, a method of forming a catalyst carrier may include providing a porous alumina body, impregnating the porous alumina body with a solution or suspension of at least one aluminate forming component to form an impregnated porous alumina body and heating the impregnated porous alumina body to form the catalyst carrier. The catalyst carrier may include a hexaaluminate phase and formation of the hexaaluminate phase may occur in-situ during heating of the impregnated porous alumina body.

### BRIEF DESCRIPTION OF THE DRAWINGS

The present disclosure can be better understood, and its numerous features and advantages made apparent to those skilled in the art by referencing the accompanying drawings.

FIG. 1 is an illustration of a flowchart of a method of making a catalyst carrier in accordance with an embodiment;

FIG. 2 is an illustration of a flowchart of a method of making a catalyst carrier in accordance with an embodiment;

FIG. 3 is an illustration of a flowchart of a method of making a catalyst carrier in accordance with an embodiment;

FIG. 4 is an illustration of a catalyst carrier in accordance with an embodiment;

FIG. 5 includes an X-ray powder diffraction (XRD) plot for sample aluminate material formed in accordance with an embodiment;

FIG. 6 includes an X-ray powder diffraction (XRD) plot for sample aluminate material formed in accordance with an embodiment; and

FIG. 7 includes an X-ray powder diffraction (XRD) plot for sample aluminate material formed in accordance with an embodiment.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

The use of the same reference symbols in different drawings indicates similar or identical items.

### DETAILED DESCRIPTION

The following description, in combination with the figures, is provided to assist in understanding the teachings disclosed herein. The following discussion will focus on specific implementations and embodiments of the teachings. This discussion is provided to assist in describing the teachings and should not be interpreted as a limitation on the scope or applicability of the teachings.

The term “averaged,” when referring to a value, is intended to mean an average, a geometric mean, or a median value. As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. As used herein, the phrase “consists essentially of” or “consisting essentially of” means that the subject that the phrase describes does not include any other components that substantially affect the property of the subject.

Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Further, references to values stated in ranges include each and every value within that range. When the terms “about” or “approximately” precede a numerical value, such as when describing a numerical range, it is intended that the exact numerical value is also included. For example, a numerical range beginning at “about 25” is intended to also include a range that begins at exactly 25. Moreover, it will be appreciated that references to values stated as “at least about,” “greater than,” “less than,” or “not greater than” can include a range of any minimum or maximum value noted therein.

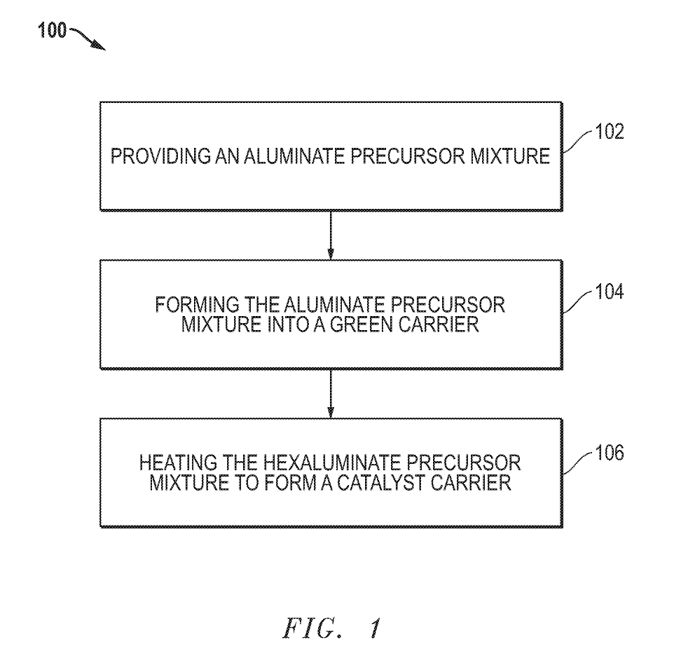

Referring initially to a first method of forming a catalyst carrier, FIG. 1 illustrates a catalyst carrier forming process generally designated 100. Catalyst carrier forming process 100 may include a first step 102 of providing an aluminate precursor mixture, a second step 104 of forming the aluminate precursor mixture into a green carrier and a third step 106 of heating the aluminate precursor mixture, e.g., the green carrier formed from the aluminate precursor mixture, to form a catalyst carrier.

According to particular embodiments, the aluminate precursor mixture provided in step 102 may include particular materials. For example, the precursor mixture provided in step 102 may include boehmite, gamma alumina, or combinations thereof and at least one aluminate forming component. According to still other embodiments, the aluminate forming component may include a soluble salt or fine powder. According to still other embodiments, the aluminate forming component may include soluble salts or fine powders of calcium, strontium, a rare earth, or combinations thereof. According to yet other embodiments, the aluminate forming component may further include another dopant selected from the group of Mg, Ba, Mn, Fe, Co, Cu, Ni and Zn.

Referring to step 104, according to certain embodiments, forming the aluminate precursor mixture into a green carrier may include using any extrusion technique that is well known in the art. Moreover, according to yet other embodiments, the green carrier can be formed using any pressing technique that is well known in the art.

According to yet other embodiments, forming the aluminate precursor mixture into a green carrier may further include adding pore forming agents, such as, for example, known organic pore forming agents to the aluminate precursor mixture.

Referring to step 106, heating the aluminate precursor mixture, e.g., the green carrier formed from the aluminate precursor mixture, to form a catalyst carrier may include heating the green carrier at a sufficient temperature and for a sufficient amount of time to form a catalyst carrier that may include a hexaaluminate phase. According to still other embodiments, heating the aluminate precursor mixture, e.g., the green carrier formed from the aluminate precursor mixture, to form a catalyst carrier may include heating the green carrier such that formation of the hexaaluminate phase occurs in-situ during heating of the green carrier.

According to still other embodiments, heating the aluminate precursor mixture, e.g., the green carrier formed from the aluminate precursor mixture, to form a catalyst carrier may include any known heating technique.

According to certain embodiments, heating the green carrier to form a catalyst carrier may include heating the green carrier at a particular temperature. For example, the green carrier formed from the aluminate precursor mixture can be heated to a temperature of at least about 500° C., such as, at least about 750° C. or at least about 1000° C. or at least about 1250° C. or at least about 1350° C. or at least about 1400° C. According to still other embodiments, the green carrier formed from the aluminate precursor mixture can be heated to a temperature of not greater than about 1800° C., such as, not greater than about 1700° C. or not greater than about 1600° C. It will be appreciated that the green carrier formed from the aluminate precursor mixture can be heated to a temperature of any value between, and including, any of the minimum and maximum values noted above. It will be further appreciated that the green carrier formed from the aluminate precursor mixture can be heated to a temperature within a range between, and including, any of the minimum and maximum values noted above.

According to other embodiments, heating the green carrier to form a catalyst carrier may include holding the green carrier at a particular temperature as noted above for a particular number of minutes. For example, the green carrier formed from the aluminate precursor mixture may be held at any of the temperatures noted above for at least about 5 minutes, such as, at least about 10 minutes or at least about 20 minutes or at least about 30 minutes or at least about 60 minutes. According to still other embodiments, the green carrier formed from the aluminate precursor mixture may be held at any of the temperatures noted above for a time not greater than 600 minutes, such as, not greater than about 540 minutes or not greater than about 480 minutes or not greater than about 420 minutes or not greater than about 360 minutes or not greater than about 300 or not greater than about 300 minutes or not greater than about 240. It will be appreciated that the green carrier formed from the aluminate precursor mixture may be held at any of the temperatures noted above for a time of any value between, and including, any of the minimum and maximum values noted above. It will be further appreciated that the green carrier formed from the aluminate precursor mixture may be held at any of the temperatures noted above for a time within a range between, and including, any of the minimum and maximum values noted above.

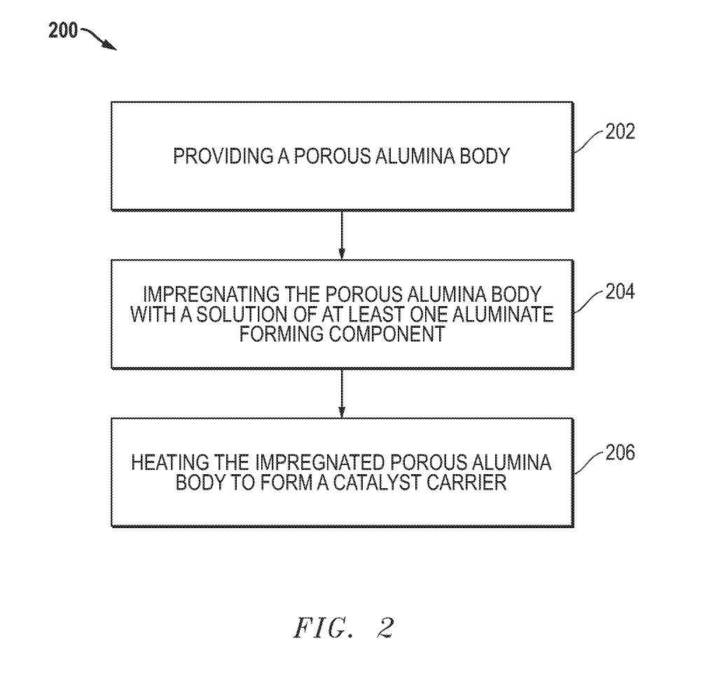

Referring now to a second method of forming a catalyst carrier, FIG. 2 illustrates a catalyst carrier forming process generally designated 200. Catalyst carrier forming process 200 may include a first step 202 of providing a porous alumina body, a second step 204 of impregnating the porous alumina body with a solution or suspension of at least one aluminate forming component and a third step 206 of heating the impregnated porous alumina body to form a catalyst carrier.

According to particular embodiments, the porous alumina body provided in step 202 may include a particular content of gamma alumina. For example, the porous alumina body may include a content of gamma alumina of at least about 70 vol. % of a total volume of the porous alumina body, such as, at least about 75 vol. % or at least about 80 vol. % or at least about 85 vol. % or at least about 90 vol. % or at least about 91 vol. % or at least about 92 vol. % or at least about 93 vol. % or at least about 94 vol. % or at least about 95 vol. % or at least about 96 vol. % or at least about 97 vol. % or at least about 98 vol. % or at least about 99 vol. %. It will be appreciated that the content of gamma alumina in the porous alumina body may be any value between, and including, any of values noted above. It will be further appreciated that content of gamma alumina in the porous alumina body may be within a range between, and including, any of the values noted above.

According to still other embodiments, the porous alumina body provided in step 202 may include a particular pore volume as measured by mercury porosimetry. For example, the porous alumina body may have a pore volume of at least 0.1 about milliliters per gram (ml/g), such as, at least about 0.2 ml/g or at least about 0.3 ml/g or at least about 0.4 mug or at least about 0.5 ml/g. According to still other embodiments, the porous alumina boy may have a pore volume of not greater than about 1.0 ml/g, such as, not greater than about 0.9 ml/g or not greater than about 0.8 ml/g or not greater than about 0.7 ml/g or not greater than about 0.6 ml/g. It will be appreciated that the porous alumina body may have a pore volume of any value between, and including, any of the minimum and maximum values noted above. It will be further appreciated that the porous alumina body may have a pore volume within a range between, and including, any of the minimum and maximum values noted above.

Referring now to step 204 and according to still other embodiments, impregnating the porous alumina body with a solution or suspension of at least one aluminate forming compound may include using a particular aluminate forming compound. For example, and as also noted in regards to the aluminate forming compound described above in conjunction with the catalyst forming process 100 of FIG. 1, the aluminate forming component may include a soluble salt or fine powder. According to still other embodiments, the aluminate forming component may include soluble salts or fine powders of calcium, strontium, a rare earth, or combinations thereof. According to yet other embodiments, the aluminate forming component may further include another dopant selected from the group of Mg, Ba, Mn, Fe, Co, Cu, Ni and Zn.

According to still other embodiments, the porous alumina body may be impregnated with the solution or suspension of at least one aluminate forming compound by spraying the porous alumina body with the solution or suspension. According to yet other embodiments, the porous alumina body can be impregnated with the solution or suspension by immersing the porous alumina body in the solution or suspension for a predetermined amount of time. According to still alternative embodiments, the porous alumina body can be impregnated using any other known technique.

Referring now to step 206, heating the impregnated porous alumina body to form a catalyst carrier may include heating the impregnated porous alumina body at a sufficient temperature and for a sufficient amount of time to form a catalyst carrier may include a hexaaluminate phase. According to still other embodiments, heating the impregnated porous alumina body to form a catalyst carrier may include heating the impregnated porous alumina body at a sufficient temperature and for a sufficient amount of time such that formation of the hexaaluminate phase in the impregnated porous alumina body occurs in-situ during heating of the impregnated porous alumina body.

According to still other embodiments, heating the impregnated porous alumina body to form a catalyst carrier may include any heating technique that is well known in the art.

According to certain embodiments, heating the impregnated porous alumina body to form a catalyst carrier may include heating the impregnated porous alumina body at a particular temperature. For example, the impregnated porous alumina body can be heated to a temperature of at least about 500° C., such as, at least about 750° C. or at least about 1000° C. or at least about 1250° C. or at least about 1350° C. or at least about 1400° C. According to still other embodiments, the impregnated porous alumina body can be heated to a temperature of not greater than about 1800° C., such as, not greater than about 1700° C. or not greater than about 1600° C. It will be appreciated that the impregnated porous alumina body can be heated to a temperature of any value between, and including, any of the minimum and maximum values noted above. It will be further appreciated that the impregnated porous alumina body can be heated to a temperature within a range between, and including, any of the minimum and maximum values noted above.

According to certain embodiments, heating the impregnated porous alumina body to form a catalyst carrier may include heating the impregnated porous alumina body at a particular temperature as noted above for a particular number of minutes. For example, the impregnated porous alumina body may be held at any of temperatures noted above for at least about 5 minutes, such as, at least about 10 minutes or at least about 20 minutes or at least about 30 minutes or at least about 60 minutes. According to still other embodiments, the impregnated porous alumina body may be held at any of the temperatures noted above for a time not greater than 600 minutes, such as, not greater than about 540 minutes or not greater than about 480 minutes or not greater than about 420 minutes or not greater than about 360 minutes or not greater than about 300 or not greater than about 300 minutes or not greater than about 240. It will be appreciated that impregnated porous alumina body may be held at any of the temperatures noted above for a time of any value between, and including, any of the minimum and maximum values noted above. It will be further appreciated that impregnated porous alumina body may be held at any of the temperatures noted above for a time within a range between, and including, any of the minimum and maximum values noted above.

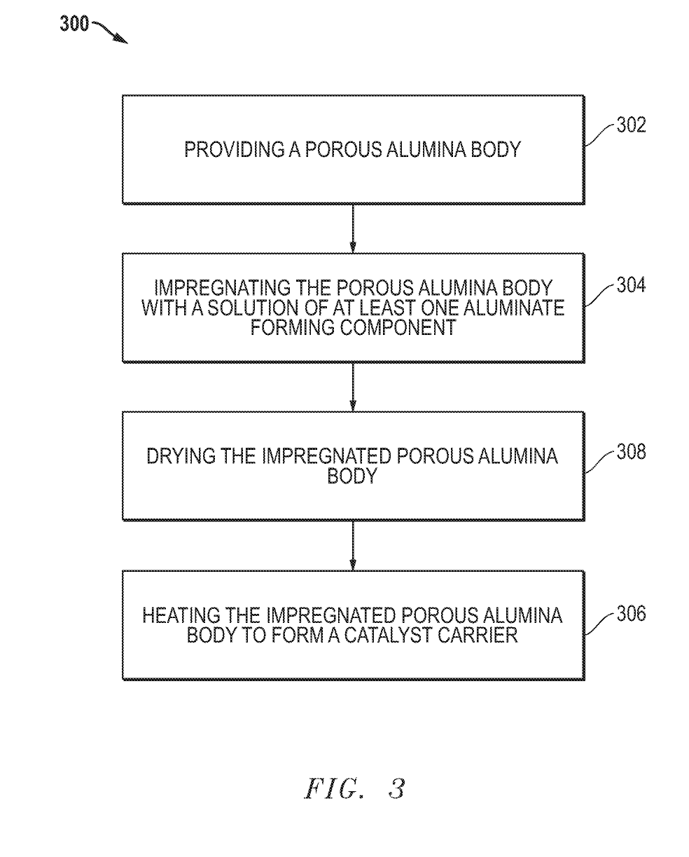

Referring now to a third method of forming a catalyst carrier, FIG. 3 illustrates a catalyst carrier forming process generally designated 300. Catalyst carrier forming process 300 may include a first step 302 of providing a porous alumina body, a second step 304 of impregnating the porous alumina body with a solution or suspension of at least one aluminate forming component, a third step 308 of drying the impregnated porous alumina body and a fourth step 306 of heating the impregnated porous alumina body to form a catalyst carrier. It will be appreciated that steps 302, 304 and 306 correspond to steps 202, 204 and 206, respectively, of catalyst carrier forming process 200 and thus may include or be carried out according to any details or component characteristics noted above in regards to steps 202, 204 and 206, respectively, of catalyst carrier forming process 200.

Referring now to step 308, according to particular embodiments, drying the impregnated porous alumina body may occur before heating of the impregnated porous alumina body as shown in FIG. 3. According to still other embodiments, drying the impregnated porous alumina body may occur during heating of the impregnated porous alumina body to form a catalyst carrier. [0041]. According to certain embodiments, drying the impregnated porous alumina body, or the catalyst carrier formed from heating the impregnated porous alumina body may include drying the impregnated porous alumina body at a particular temperature. For example, the impregnated porous alumina body can be dried at a temperature of at least about 75° C., such as, at least about 100° C. or at least about 150° C. or at least about 200° C. or at least about 300° C. According to still other embodiments, the impregnated porous alumina body can be dried at a temperature of not greater than about 1750° C., such as, not greater than about 1500° C. or not greater than about 1250° C. or not greater than about 1000° C. or not greater than about 750° C. It will be appreciated that the impregnated porous alumina body can be dried at a temperature of any value between, and including, any of the minimum and maximum values noted above. It will be further appreciated that the impregnated porous alumina body can be dried at a temperature within a range between, and including, any of the minimum and maximum values noted above.

According to certain embodiments, drying the impregnated porous alumina body, or the catalyst carrier formed from heating the impregnated porous alumina body may include drying the impregnated porous alumina body at a particular temperature as noted above for a particular number of minutes. For example, the impregnated porous alumina body may be dried at any of the temperatures noted above for at least about 5 minutes, such as, at least about 30 minutes or at least about 60 minutes or at least about 120 minutes or at least about 240 minutes. According to still other embodiments, the impregnated porous alumina body may be dried at any of the temperatures noted above for a time not greater than 600 minutes, such as, not greater than about 480 minutes or not greater than about 360 minutes. It will be appreciated that impregnated porous alumina body may be dried at any of the temperatures noted above for a time of any value between, and including, any of the minimum and maximum values noted above. It will be further appreciated that impregnated porous alumina body may be dried at any of the temperatures noted above for a time within a range between, and including, any of the minimum and maximum values noted above.

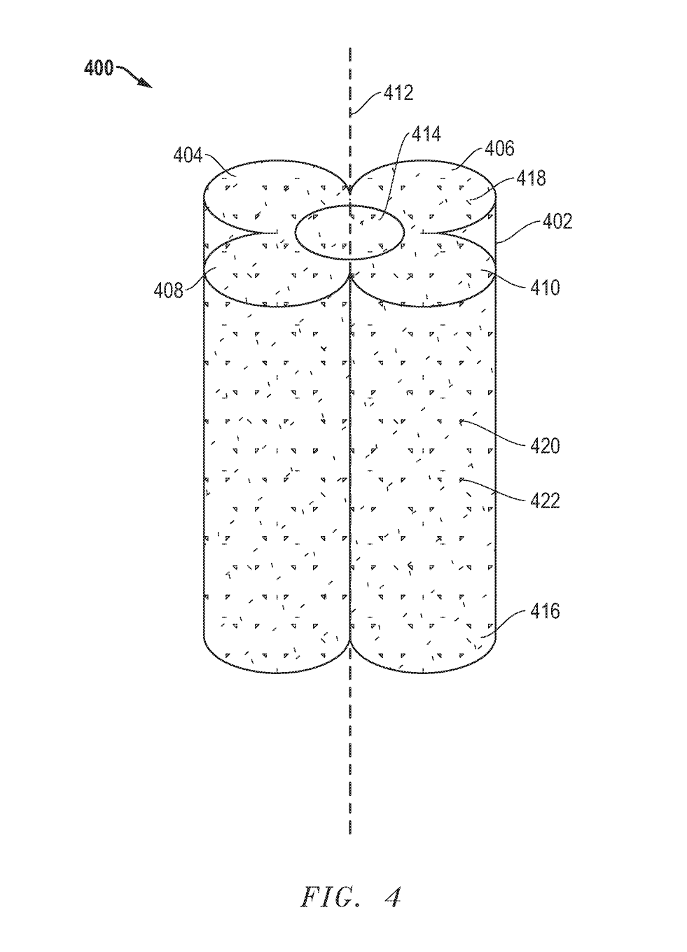

Referring now to the catalyst carrier formed according to embodiments described herein in regards to catalyst carrier forming processes 100, 200 or 300, FIG. 4 includes an illustration of a catalyst carrier 400. According to particular embodiments, catalyst carrier 400 may be a porous structure that acts as a catalyst itself or a porous structure that may be combined with other active catalyst phases.

As shown in FIG. 4, the catalyst carrier 400 can include a body 402. It will be appreciated that the body 402 of the catalyst carrier 400 may be any three dimensional shape that may function as a catalyst carrier as described herein. According to certain embodiments, the body 402 of the catalyst carrier 400 may be any extruded three dimension shape that may function as a catalyst carrier as described herein. According to still other embodiments, the body 402 of the catalyst carrier 400 may have a spheronized ball shape, an extruded pentaring shape, an extruded ring shape, a extruded pressed ring shape, an extruded trilobes shape, an extruded quadrilobe shape or an extruded pellet shape.

As shown in FIG. 4 for purposes of illustration, the body 402 may have an extruded quadrilobe shape such that the catalyst carrier 400 can have a cross-section that is shaped like a quadrilobe, i.e., like a cloverleaf having four leaves. Specifically, the body 402 can include a first generally cylindrical lobe portion 404, a second generally cylindrical lobe portion 406, a third generally cylindrical lobe portion 408, and a fourth generally cylindrical lobe portion 410. The lobe portions 404, 406, 408, 410 can be equally spaced around a central axis 412 defined by the body 402 of the catalyst carrier 400. Further, the body 402 of the catalyst carrier 400 can include a generally cylindrical bore 414 extending along the central axis 412 through the entire length of the body 402 of the catalyst carrier 400, e.g., from a first end 416 of the body 402 to a second end 418 of the body 402.

According to certain embodiments, the catalyst carrier 400 may includes an aluminate based body and the aluminate may include a hexaaluminate phase.

According to other embodiments, a catalyst carrier 400 may include a particular hexaaluminate phase content. For example, a catalyst carrier 400 may include a hexaaluminate phase content of at least about 70 vol. % of a total volume of the catalyst carrier, such as, at least about 75 vol. % or at least 80 vol. % or at least about 85 vol. % or at least about 90 vol. % or at least about 95 vol. %. It will be appreciated that a catalyst carrier 400 may include a hexaaluminate phase content of any value between, and including, any of the values noted above. It will be further appreciated that a catalyst carrier 400 may include a hexaaluminate phase content within a range between, and including, any of the values noted above.

According to yet other embodiments, a catalyst carrier 400 may include a particular content of spinel. For example, a catalyst carrier 400 may include a spinel content of not greater than about 30 vol. % of a total volume of the catalyst carrier, such as, not greater than about 25 vol. % or not greater than about 20 vol. % or not greater than about 15 vol. % or not greater than about 10 vol. % or not greater than about 5 vol. % or not greater than about 1 vol. %. It will be appreciated that the spinel content may be any value between, and including, any of values noted above. It will be further appreciated that the spinel content may be within a range between, and including, any of the values noted above.

According to still other embodiments, a catalyst carrier 400 may include a particular content of perovskite phase. For example, a catalyst carrier 400 may include a perovskite phase content of not greater than about 30 vol. % of a total volume of the catalyst carrier, such as, not greater than about 25 vol. % or not greater than about 20 vol. % or not greater than about 15 vol. % or not greater than about 10 vol. % or not greater than about 5 vol. % or not greater than about 1 vol. %. It will be appreciated that the perovskite phase content may be any value between, and including, any of values noted above. It will be further appreciated that the perovskite phase content may be within a range between, and including, any of the values noted above.

According to other embodiments, a catalyst carrier 400 may include a particular content of α-alumina phase. For example, a catalyst carrier 400 may include a α-alumina phase content of not greater than about 30 vol. % of a total volume of the catalyst carrier, such as, not greater than about 25 vol. % or not greater than about 20 vol. % or not greater than about 15 vol. % or not greater than about 10 vol. % or not greater than about 5 vol. % or not greater than about 1 vol. %. It will be appreciated that the α-alumina phase content may be any value between, and including, any of values noted above. It will be further appreciated that the α-alumina phase content may be within a range between, and including, any of the values noted above.

According to yet other embodiments, the hexaaluminate phase of the body 402 of the catalyst carrier 400 may include a magnetoplumbite phase, a ß-aluminate phase or combinations thereof.

According to still other embodiments, the hexaaluminate phase may include a particular content of magnetoplumbite phase. For example, the hexaaluminate phase may include a magnetoplumbite phase content of at least about 50 vol. % of a total volume of the hexaaluminate phase, such as, at least about 60 vol. % or at least about 70 vol. % or at least about 75 vol. % or at least about 80 vol. % or at least about 85 vol. % or at least about 90 vol. % or at least 95 vol. % or at least 99 vol. %. It will be appreciated that the hexaaluminate phase may include a magnetoplumbite phase content of any value between, and including, any of the values noted above. It will be further appreciated that the hexaaluminate phase may include a magnetoplumbite phase content within a range between, and including, any of the values noted above.

According to yet other embodiments, the hexaaluminate phase of the body 402 of the catalyst carrier 400 may have a particular formula. For example, the hexaaluminate phase of the body 402 of the catalyst carrier 400 may have a formula M₁₋ₓD_{y}LnₓAl₁₂₋ₓO_{19-x+y}, MD_{y}LnₓAl₁₂₋ₓO_{19+y} or MₓD_{y}LnAl₁₁O_{18+x+y}, where M is selected from the group consisting of Ca and Sr, where D is selected from the group consisting of Mg, Ba, Mn, Fe, Co, Cu, Ni, Zn, where Ln is selected from the group consisting of praseodymium, samarium, europium, holmium, lanthanum, gadolinium, dysprosium, neodymium, erbium, and mixtures thereof, where 1≥x≥0, and where 1≥y≥0.

According to still other embodiments, the hexaaluminate phase of the body 402 of the catalyst carrier 400 may have a formula of LaAl₁₁O₁₈, LaZnAl₁₁O₁₉, LaMgAl₁₁O₁₉, LaSrAl₁₁O₁₉, LaMnAl₁₁O₁₉, LaFeAl₁₁O₁₉, LaCuAl₁₁O₁₉, LaCoAl₁₁O₁₉, LaNiAl₁₁O₁₉, SrAl₁₂O₁₉, Sr_{0.5}Mn_{0.5}Al₁₂O₁₉, Sr_{0.5}Fe_{0.5}Al₁₂O₁₉, CaAl₁₂O₁₉, Ca_{0.5}Mn_{0.5}Al₁₂O₁₉, Ca_{0.5}Fe_{0.5}Al₁₂O₁₉ or any combination thereof.

According to yet other embodiments, the catalyst carrier 400 may have a particular combined content of any oxides of M elements and any oxides of Ln compounds Further, the catalyst carrier 400 can include a combined content of any oxides of M elements, any oxides of D elements and any oxides of Ln compounds, where M is selected from the group consisting of Ca and Sr, where D is selected from the group consisting of Mg, Ba, Mn, Fe, Co, Cu, Ni, Zn, and where Ln is selected from the group consisting of praseodymium, samarium, europium, holmium, lanthanum, gadolinium, dysprosium, neodymium, erbium, and mixtures thereof. For example, the combined content of any oxides of M elements, any oxides of D elements and any oxides of Ln compounds may be at least about 10 vol. % of a total volume of the catalyst carrier, such as, at least about 20 vol. % or at least about 30 vol. % or at least about 40 vol. % or at least about 50 vol. % According to still other embodiments, the combined content of any oxides of M elements, any oxides of D elements and any oxides of Ln compounds may be not greater than about 60 vol. % or not greater than about 58 vol. % or not greater than about 55 vol. % or not greater than about 53 vol. %. It will be appreciated the combined content of any oxides of M elements, any oxides of D elements and any oxides of Ln compounds may be any value between, and including, any of the minimum and maximum values noted above. It will be further appreciated that the combined content of any oxides of M elements and any oxides of Ln compounds may be within a range between, and including, any of the minimum and maximum values noted above.

According to yet other embodiments, the catalyst carrier 400 may include a particular Al₂O₃ content. For example, the catalyst carrier 400 may include a Al₂O₃ content of at least about 60 vol. % of a total volume of the catalyst carrier, such as, at least about 65 vol. % or at least about 70 vol. % or at least about 75 vol. % or at least about 80 vol. % or at least about 85 vol. %. According to still other embodiments, the catalyst carrier 400 may include a Al₂O₃ content of not greater than about 90 vol. % of a total volume of the catalyst carrier, such as, not greater than about 89 vol. % or not greater than about 88 vol. % or not greater than about 87 vol. % or not greater than about 86 vol. %. It will be appreciated the Al₂O₃ content may be any value between, and including, any of the minimum and maximum values noted above. It will be further appreciated that the Al₂O₃ content may be within a range between, and including, any of the minimum and maximum values noted above.

According to yet other embodiments, the catalyst carrier 400 may include a particular SiO₂ content. For example, the SiO₂ content may be not greater than about 5 vol. % of a total volume of the catalyst carrier, such as, not greater than about 4 vol. % or not greater than about 3 vol. % or not greater than about 2 vol. % or not greater than about 1 vol. % or not greater than about 0.5 vol. % or not grater than about 0.1 vol. %. It will be appreciated the SiO₂ content may be any value between, and including, any of the values noted above. It will be further appreciated that the SiO₂ content may be within a range between, and including, any of the values noted above.

According to yet other embodiments, the catalyst carrier 400 may include a particular alkali oxides content. For example, the alkali oxides content may be not greater than about 5 vol. % of a total volume of the catalyst carrier, such as, not greater than about 4 vol. % or not greater than about 3 vol. % or not greater than about 2 vol. % or not greater than about 1 vol. % or not greater than about 0.5 vol. % or not grater than about 0.1 vol. %. It will be appreciated the alkali oxides content may be any value between, and including, any of the values noted above. It will be further appreciated that the alkali oxides content may be within a range between, and including, any of the values noted above.

As further illustrated in FIG. 4, the body 402 of the catalyst carrier 400 can include a plurality of particles 420 dispersed throughout the body 402. In particular embodiments, the particles 420 may be in the shape of platelets.

According to certain embodiments, the platelets may include a particular hexaaluminate phase content. For example, the platelets may include a hexaaluminate phase content of at least about 70 vol. % of a total volume of the catalyst carrier, such as, at least about 75 vol. % or at least 80 vol. % or at least about 85 vol. % or at least about 90 vol. % or at least about 95 vol. %. It will be appreciated that the platelets may include a hexaaluminate phase content of any value between, and including, any of the values noted above. It will be further appreciated that the platelets may include a hexaaluminate phase content within a range between, and including, any of the values noted above.

According to still other embodiments, the catalyst carrier 400 may include a particular platelet content. For example, the catalyst carrier 400 may include a platelet content of at least about 70 vol. % of a total volume of the catalyst carrier, such as, at least about 85 vol. % or at least about 90 vol. % or at least about 95 vol. % or at least about 99 vol. %. It will be appreciated that the platelet content may be any value between, and including, any of the values noted above. It will be further appreciated that the platelet content may be within a range between, and including, any of the values noted above.

According to yet other embodiments, the platelets may have a particular average diameter. For example, the average diameter of the platelets may be at least about 0.1 microns, such as, at least about 0.2 microns or at least about 0.3 microns or at least about 0.4 microns or at least about 0.5 microns or at least about 1 micron. According to still other embodiments, the platelets may have a diameter of not greater than about 10 microns, such as, not greater than about 9 microns or not greater than about 8 microns or not greater than about 7 microns or not greater than about 6 microns or not greater than about 5 microns. It will be appreciated that the platelets may have an average diameter of any value between, and including, any of the minimum and maximum values noted above. It will be further appreciated that the platelets may have an average diameter within a range between, and including, any of the minimum and maximum values noted above.

According to yet other embodiments, the platelets may have a particular average aspect ratio, where the aspect ratio is equal to the ratio between the diameter of the platelet and the thickness of the platelet. For example, the average aspect ratio of the platelets may be at least about 2, such as, at least about 3 or at least about 4 or at least about 5. According to still other embodiments, the platelets may have an average aspect ratio of not greater than about 20, such as, not greater than about 15 or not greater than about 14 or not greater than about 13 or not greater than about 12 or not greater than about 11 or not greater than about 10. It will be appreciated that the platelets may have an average aspect ratio of any value between, and including, any of the minimum and maximum values noted above. It will be further appreciated that the platelets may have an average aspect ratio within a range between, and including, any of the minimum and maximum values noted above.

According to yet other embodiments, the platelets may have a hexagonal shape.

According to still other embodiments, the catalyst carrier 400 may have a plurality of pores 422. According to still other embodiments, the catalyst carrier 400 may include a particular porosity content. For example, the catalyst carrier 400 may have a porosity content of at least about 20 vol. % of a total volume of the catalyst carrier, such as, at least about 30 vol. % or at least about 40 vol. % or at least about 50 vol. %. According to still other embodiments, the catalyst carrier 400 may have a porosity content of not greater than about 85 vol. %, such as, not greater than about 80 vol. % or not greater than about 70 vol. %. It will be appreciated that the catalyst carrier 400 may have a porosity content of any value between, and including, any of the minimum and maximum values noted above. It will be further appreciated that the catalyst carrier 400 may have a porosity content within a range between, and including, any of the minimum and maximum values noted above.

According to yet other embodiments, the catalyst carrier 400 may include a particular specific surface area as measured by Brunauer-Emmett-Teller (BET) N₂ adsorption method. For example, the catalyst carrier 400 may have a specific surface area of not greater than about 20 meters squared per gram (m²/g), such as, not greater than about 18 m²/g or not greater than about 15 m²/g or not greater than about 13 or not greater than about 10 m²/g or not greater than about 8 or not greater than about 5 m²/g. According to still other embodiments, the catalyst carrier 400 may have a specific surface area of at least about 0.5 m²/g, such as, at least about 1 m²/g or at least about 2 m²/g or at least about 3 m²/g or at least about 4 m²/g or at least about 5 m²/g. It will be appreciated that the catalyst carrier 400 may have a specific surface area of any value between, and including, any of the minimum and maximum values noted above. It will be further appreciated that the catalyst carrier 400 may have a specific surface area within a range between, and including, any of the minimum and maximum values noted above.

According to still other embodiments, the catalyst carrier 400 may include a particular porosity volume as measured by mercury porosimetry according to ASTM D4284-12. For example, the catalyst carrier 400 may have a porosity volume of at least about 0.05 milliliters per gram (ml/g), such as, at least about 0.1 ml/g or as at least about 0.2 ml/g or at least about 0.3 ml/g or at least about 0.4 ml/g or at least about 0.5 ml/g. According to still other embodiments, the catalyst carrier 400 may have a pore volume of not greater than about 1.0 ml/g, such as, not greater than about 0.9 ml/g or not greater than about 0.8 ml/g or not greater than about 0.7 ml/g or not greater than about 0.6 ml/g. It will be appreciated that the catalyst carrier 400 may have a porosity volume of any value between, and including, any of the minimum and maximum values noted above. It will be further appreciated that the catalyst carrier 400 may have a porosity volume within a range between, and including, any of the minimum and maximum values noted above.

According to still other embodiments, the catalyst carrier 400 may include a particular crush strength as measured according to ASTM D4179-11 for single pellet crush strength. For example, the catalyst carrier 400 may have a crush strength of at least about 10 MPa, such as, at least about 20 MPa or as at least about 30 MPa or at least about 40 MPa or at least about 50 MPa or at least about 100 MPa. According to still other embodiments, the catalyst carrier 400 may have a crush strength of not greater than about 500 MPa, such as, not greater than about 400 MPa or not greater than about 300 MPa or not greater than about 200 MPa. It will be appreciated that the catalyst carrier 400 may have a crush strength of any value between, and including, any of the minimum and maximum values noted above. It will be further appreciated that the catalyst carrier 400 may have a crush strength within a range between, and including, any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiment 1

A catalyst carrier comprising an aluminate based body, wherein the aluminate comprises a hexaaluminate phase and wherein the catalyst carrier has a specific surface area of not greater than about 20 m²/g.

### Embodiment 2

The catalyst carrier of embodiment 1, wherein the catalyst carrier comprises a hexaaluminate phase content of at least about 70 vol. % of a total volume of the catalyst carrier.

### Embodiment 3

The catalyst carrier of embodiment 1, wherein the catalyst carrier comprises a spinel content of not greater than about 30 vol. % of a total volume of the catalyst carrier or not greater than about 5 vol. % or not greater than about 1 vol. %.

### Embodiment 4

The catalyst carrier of embodiment 1, wherein the catalyst carrier comprises a perovskite phase content of not greater than about 30 vol. % of a total volume of the catalyst carrier or not greater than about 5 vol. % or not greater than about 1 vol. %.

### Embodiment 5

The catalyst carrier of embodiment 1, wherein the catalyst carrier comprises a α-alumina phase content of not greater than about 30 vol. % of a total volume of the catalyst carrier or not greater than about 5 vol. % or not greater than about 1 vol. %.

### Embodiment 6

The catalyst carrier of embodiment 1, wherein the hexaaluminate phase comprises a magnetoplumbite phase, a ß-aluminate phase or combinations thereof.

### Embodiment 7

The catalyst carrier of embodiment 1, wherein at least about 50 vol. % of the hexaaluminate phase is a magnetoplumbite phase.

### Embodiment 8

The catalyst carrier of embodiment 1, wherein the hexaaluminate phase has a formula M₁₋ₓD_{y}LnₓAl₁₂₋ₓO_{19-x+y}, MD_{y}LnₓAl₁₂₋ₓO_{19+y} or MₓD_{y}LnAl₁₁O_{18+x+y}, where M is selected from the group consisting of Ca and Sr, where D is selected from the group consisting of Mg, Ba, Mn, Fe, Co, Cu, Ni, Zn, where Ln is selected from the group consisting of praseodymium, samarium, europium, holmium, lanthanum, gadolinium, dysprosium, neodymium, erbium, and mixtures thereof, where 1≥x≥0, and where 1≥y≥0.

### Embodiment 9

The catalyst carrier of embodiment 1, wherein the hexaaluminate phase has a formula of LaAl₁₁O₁₈, LaZnAl₁₁O₁₉, LaMgAl₁₁O₁₉, LaSrAl₁₁O₁₉, LaMnAl₁₁O₁₉, LaFeAl₁₁O₁₉, LaCuAl₁₁O₁₉, LaCoAl₁₁O₁₉, LaNiAl₁₁O₁₉, SrAl₁₂O₁₉, Sr_{0.5}Mn_{0.5}Al₁₂O₁₉, Sr_{0.5}Fe_{0.5}Al₁₂O₁₉, CaAl₂O₁₉, Ca_{0.5}Mn_{0.5}Al₁₂O₁₉, Ca_{0.5}Fe_{0.5}Al₁₂O₁₉ and any combination thereof.

### Embodiment 10

The catalyst carrier of embodiment 1, wherein the catalyst carrier comprises a combined content of any oxides of M elements and any oxides of Ln compounds of at least about 10 vol. % of a total volume of the catalyst carrier, where M is selected from the group consisting of CA and Sr, where D is selected from the group consisting of Mg, Ba, Mn, Fe, Co, Cu, Ni, Zn, and where Ln is selected from the group consisting of praseodymium, samarium, europium, holmium, lanthanum, gadolinium, dysprosium, neodymium, erbium, and mixtures thereof.

### Embodiment 11

The catalyst carrier of embodiment 1, wherein the catalyst carrier comprises a combined content of any oxides of M elements and any oxides of Ln compounds of not greater than about 50 vol. % of a total volume of the catalyst carrier, where M is selected from the group consisting of CA and Sr, where D is selected from the group consisting of Mg, Ba, Mn, Fe, Co, Cu, Ni, Zn, and where Ln is selected from the group consisting of praseodymium, samarium, europium, holmium, lanthanum, gadolinium, dysprosium, neodymium, erbium, and mixtures thereof.

### Embodiment 12

The catalyst carrier of embodiment 1, wherein the catalyst carrier comprises an Al₂O₃ content of at least about 60 vol. % of a total volume of the catalyst carrier.

### Embodiment 13

The catalyst carrier of embodiment 1, wherein the catalyst carrier comprises an Al₂O₃ content of not greater than about 90 vol. % of a total volume of the catalyst carrier.

### Embodiment 14

The catalyst carrier of embodiment 1, wherein the catalyst carrier comprises a SiO₂ content of not greater than about 5 vol. % of a total volume of the catalyst carrier or not greater than about 0.1 vol. % of a total volume of the catalyst carrier.

### Embodiment 15

The catalyst carrier of embodiment 1, wherein the catalyst carrier comprises a total content of alkali oxides of not greater than about 5 vol. % of a total volume of the catalyst carrier or not greater than about 0.1 vol. % of a total volume of the catalyst carrier.

### Embodiment 16

The catalyst carrier of embodiment 1, wherein the catalyst carrier comprises particles in the shape of platelets.

### Embodiment 17

The catalyst carrier of embodiment 16, wherein the platelets comprise a hexaaluminate phase.

### Embodiment 18

The catalyst carrier of embodiment 16, wherein catalyst carrier comprises a platelet content of at least about 70 vol. % of a total volume of the catalyst carrier or at least about 95 vol. % or at least about 99 vol. %.

### Embodiment 19

The catalyst carrier of embodiment 16, wherein the platelets comprise an average diameter of at least about 0.1 microns and not greater than about 10 microns, preferably at least about 0.5 microns and not greater than about 5 microns.

### Embodiment 20

The catalyst carrier of embodiment 16, wherein the platelets comprise an average aspect ratio of at least about 2 and not greater than about 20, preferably at least about 5 and not greater than about 10, where the aspect ratio is equal to the ratio between the diameter of the platelet and the thickness of the platelet.

### Embodiment 21

The catalyst carrier of embodiment 16, wherein the platelets have a hexagonal shape.

### Embodiment 22

The catalyst carrier of embodiment 1, wherein the catalyst carrier comprises a porosity content of at least about 20 vol. % of a total volume of the catalyst carrier.

### Embodiment 23

The catalyst carrier of embodiment 1, wherein the catalyst carrier comprises an open porosity content of not greater than about 85 vol. % of a total volume of the catalyst carrier.

### Embodiment 24

The catalyst carrier of embodiment 1, wherein the catalyst carrier comprises a specific surface area of not greater than about 20 m²/g.

### Embodiment 25

The catalyst carrier of embodiment 1, wherein the catalyst carrier comprises a specific surface area of at least about 0.5 m²/g.

### Embodiment 26

The catalyst carrier of embodiment 1, wherein the catalyst carrier comprises a pore volume of at least about 0.05 ml/g.

### Embodiment 27

The catalyst carrier of embodiment 1, wherein the catalyst carrier comprises a pore volume of not greater than about 1 ml/g.

### Embodiment 28

The catalyst carrier of embodiment 1, wherein the catalyst carrier comprises a crush strength of at least about 10 MPa.

### Embodiment 29

The catalyst carrier of embodiment 1, wherein the catalyst carrier comprises a crush strength of not greater than about 500 MPa.

### Embodiment 30

The catalyst carrier of embodiment 1, wherein the catalyst carrier has an extruded pentaring shape, a spheronized ball shape, an extruded ring shape, a pressed ring shape, an extruded trilobes shape, an extruded pellets shape, an extruded quadrilobes shape.

### Embodiment 31

A method of forming a catalyst carrier, wherein the method comprises: providing an aluminate precursor mixture; forming the aluminate precursor mixture into a green carrier; and heating the aluminate precursor mixture to form the catalyst carrier, wherein the catalyst carrier comprises a hexaaluminate phase, and wherein formation of the hexaaluminate phase occurs in-situ during heating of the aluminate precursor mixture.

### Embodiment 32

The method of embodiment 31, wherein the aluminate precursor mixture comprises: boehmite, gamma alumina or combinations thereof; and at least one aluminate forming component.

### Embodiment 33

A method of forming a catalyst carrier, wherein the method comprises: providing a porous alumina body; impregnating the porous alumina body with a solution or suspension of at least one aluminate forming component to form an impregnated porous alumina body; heating the impregnated porous alumina body to form the catalyst carrier, wherein the catalyst carrier comprises a hexaaluminate phase, and wherein formation of the hexaaluminate phase occurs in-situ during heating of the impregnated porous alumina body.

### Embodiment 34

The method of embodiment 33, wherein the method further comprises drying the impregnated porous alumina body.

### Embodiment 35

The method of embodiment 33, wherein the porous alumina body comprises gamma alumina.

### Embodiment 36

The method of embodiment 33, wherein the porous alumina body comprises a pore volume of at least about 0.5 ml/g.

### Embodiment 37

The method of embodiment 33, wherein the porous alumina body comprises a pore volume of not greater than about 1 ml/g.

### Embodiment 38

The method of any one of embodiments 32 and 33, wherein the aluminate forming component comprises a soluble salt or fine powder.

### Embodiment 39

The method of any one of embodiments 32 and 33, wherein the aluminate forming component comprises soluble salts or fine powders of calcium, strontium a rare earth or combinations thereof and, optionally, a dopant selected from the group of Mg, Ba, Mn, Fe, Co, Cu, Ni and Zn.

### Embodiment 40

The method of any one of embodiments 32 and 33, wherein the catalyst carrier comprises a hexaaluminate phase content of at least about 70 vol. % of a total volume of the catalyst carrier.

### Embodiment 41

The method of any one of embodiments 32 and 33, wherein the catalyst carrier comprises a spinel content of not greater than about 30 vol. % of a total volume of the catalyst carrier or not greater than about 5 vol. % or not greater than about 1 vol. %.

### Embodiment 42

The method of any one of embodiments 32 and 33, wherein the catalyst carrier comprises a perovskite phase content of not greater than about 30 vol. % of a total volume of the catalyst carrier or not greater than about 5 vol. % or not greater than about 1 vol. %.

### Embodiment 43

The method of any one of embodiments 32 and 33, wherein the catalyst carrier comprises a α-alumina phase content of not greater than about 30 vol. % of a total volume of the catalyst carrier or not greater than about 5 vol. % or not greater than about 1 vol. %.

### Embodiment 44

The method of any one of embodiments 32 and 33, wherein the hexaaluminate phase comprises a magnetoplumbite phase, a 8-aluminate phase or combinations thereof.

### Embodiment 45

The method of any one of embodiments 32 and 33, wherein at least about 50 vol. % of the hexaaluminate phase is a magnetoplumbite phase.

### Embodiment 46

The method of any one of embodiments 32 and 33, wherein the hexaaluminate phase has a formula M₁₋ₓD_{y}LnₓAl₁₂₋ₓO_{19-x+y}, MD_{y}LnₓAl₁₂₋ₓO_{19+y} or MₓD_{y}LnAl₁₁O_{18+x+y}, where M is selected from the group consisting of Ca and Sr, where D is selected from the group consisting of Mg, Ba, Mn, Fe, Co, Cu, Ni, Zn, where Ln is selected from the group consisting of praseodymium, samarium, europium, holmium, lanthanum, gadolinium, dysprosium, neodymium, erbium, and mixtures thereof, where 1≥x≥0, and where 1≥y≥0.

### Embodiment 47

The method of any one of embodiments 32 and 33, wherein the hexaaluminate phase has a formula of LaAl₁₁O₁₈, LaZnAl₁₁O₁₉, LaMgAl₁₁O₁₉, LaSrAl₁₁O₁₉, LaMnAl₁O₁₉, LaFeAl₁₁O₁₉, LaCuAl₁₁O₁₉, LaCoAl₁₁O₁₉, LaNiAl₁₁O₁₉, SrAl₁₂O₁₉, Sr_{0.5}Mn_{0.5}Al₁₂O₁₉, Sr_{0.5}Fe_{0.5}Al₁₂O₁₉, CaAl₁₂O₁₉, Ca_{0.5}Mn_{0.5}Al₁₂O₁₉, Ca_{0.5}Fe_{0.5}Al₁₂O₁₉ and any combination thereof.

### Embodiment 48

The method of any one of embodiments 32 and 33, wherein the catalyst carrier comprises a combined content of any oxides of M elements and any oxides of Ln compounds of at least about 10 vol. % of a total volume of the catalyst carrier, where M is selected from the group consisting of CA and Sr, where D is selected from the group consisting of Mg, Ba, Mn, Fe, Co, Cu, Ni, Zn, and where Ln is selected from the group consisting of praseodymium, samarium, europium, holmium, lanthanum, gadolinium, dysprosium, neodymium, erbium, and mixtures thereof.

### Embodiment 49

The method of any one of embodiments 32 and 33, wherein the catalyst carrier comprises a combined content of any oxides of M elements and any oxides of Ln compounds of not greater than about 50 vol. % of a total volume of the catalyst carrier, where M is selected from the group consisting of Ca and Sr, where D is selected from the group consisting of Mg, Ba, Mn, Fe, Co, Cu, Ni, Zn, and where Ln is selected from the group consisting of praseodymium, samarium, europium, holmium, lanthanum, gadolinium, dysprosium, neodymium, erbium, and mixtures thereof.

### Embodiment 50

The method of any one of embodiments 32 and 33, wherein the catalyst carrier comprises an Al₂O₃ content of at least about 60 vol. % of a total volume of the catalyst carrier.

### Embodiment 51

The method of any one of embodiments 32 and 33, wherein the catalyst carrier comprises an Al₂O₃ content of not greater than about 90 vol. % of a total volume of the catalyst carrier.

### Embodiment 52

The method of any one of embodiments 32 and 33, wherein the catalyst carrier comprises a SiO₂ content of not greater than about 5 vol. % of a total volume of the catalyst carrier or not greater than about 0.1 vol. % of a total volume of the catalyst carrier.

### Embodiment 53

The method of any one of embodiments 32 and 33, wherein the catalyst carrier comprises a total content of alkali oxides of not greater than about 5 vol. % of a total volume of the catalyst carrier or not greater than about 0.1 vol. % of a total volume of the catalyst carrier.

### Embodiment 54

The method of any one of embodiments 32 and 33, wherein the catalyst carrier comprises particles in the shape of platelets.

### Embodiment 55

The method of embodiment 54, wherein the platelets comprise a hexaaluminate phase.

### Embodiment 56

The method of embodiment 54, wherein catalyst carrier comprises a platelet content of at least about 70 vol. % of a total volume of the catalyst carrier or at least about 95 vol. % or at least about 99 vol. %.

### Embodiment 57

The method of embodiment 54, wherein the platelets comprise an average diameter of at least about 0.1 microns and not greater than about 10 microns, preferably at least about 0.5 microns and not greater than about 5 microns.

### Embodiment 58

The method of embodiment 54, wherein the platelets comprise an average aspect ratio of at least about 2 and not greater than about 20, preferably at least about 5 and not greater than about 10, where the aspect ratio is equal to the ratio between the diameter of the platelet and the thickness of the platelet.

### Embodiment 59

The method of embodiment 54, wherein the platelets have a hexagonal shape.

### Embodiment 60

The method of any one of embodiments 32 and 33, wherein the catalyst carrier comprises a porosity content of at least about 20 vol. % of a total volume of the catalyst carrier.

### Embodiment 61

The method of any one of embodiments 32 and 33, wherein the catalyst carrier comprises an open porosity content of not greater than about 85 vol. % of a total volume of the catalyst carrier.

### Embodiment 62

The method of any one of embodiments 32 and 33, wherein the catalyst carrier comprises a specific surface area of not greater than about 20 m²/g.

### Embodiment 63

The method of any one of embodiments 32 and 33, wherein the catalyst carrier comprises a specific surface area of at least about 0.5 m²/g.

### Embodiment 64

The method of any one of embodiments 32 and 33, wherein the catalyst carrier comprises a pore volume of at least about 0.05 ml/g.

### Embodiment 65

The method of any one of embodiments 32 and 33, wherein the catalyst carrier comprises a pore volume of not greater than about 1 ml/g.

### Embodiment 66

The method of any one of embodiments 32 and 33, wherein the catalyst carrier comprises a crush strength of at least about 10 MPa.

### Embodiment 67

The method of any one of embodiments 32 and 33, wherein the catalyst carrier comprises a crush strength of not greater than about 500 MPa.

### Embodiment 68

The method of any one of embodiments 32 and 33, wherein the catalyst carrier has an extruded pentaring shape, a speronized ball shape, an extruded ring shape, a pressed ring shape, an extruded trilobes shape, an extruded pellets shape, an extruded quadrilobes shape.

### EXAMPLES

Twelve sample aluminate materials S1-S12 were formed according to embodiments described herein. Each sample aluminate material S1-S12 was formed through impregnation of a porous alumina body with a solution or suspension of an aluminate forming component. The porous alumina body used to form each sample aluminate material S1-S12 was a gamma alumina porous body (i.e., an alumina body that includes at least 95 vol. % gamma alumina of a total volume of the porous body) and had a mass of 20 grams.

Table 1 below summarizes the impregnation solution or suspension composition, and heating hold time for each sample aluminate material S1-S12. Each sample was heated up at a heating pace of 500° C. per hour until they reached a temperature of 1500° C.

TABLE 1
Sample Aluminate Material Forming Materials and Conditions

| | | Mass of Aluminate Forming | | | | |
|---|---|---|---|---|---|---|
| | Aluminate | Component in Solution/Suspension (g) * | | | | Heating |
| | Forming | La | Mg | Mn | Sr | Hold |
| Sam- | Compo- | Nitrate | Nitrate | Nitrate | Ni- | Time |
| ple | nent | Hexahydrate | Hexahydrate | Hydrate | trate | (min) |
| S1 | LaMg | 11.57 | 6.84 | N/A | N/A | 180 |
| S2 | LaMg | 13.11 | 7.75 | N/A | N/A | 180 |
| S3 | LaMg | 11.57 | 6.84 | N/A | N/A | 10 |
| S4 | LaMg | 13.11 | 7.75 | N/A | N/A | 10 |
| S5 | Sr | N/A | N/A | N/A | 5.18 | 180 |
| S6 | Sr | N/A | N/A | N/A | 5.87 | 180 |
| S7 | Sr | N/A | N/A | N/A | 5.18 | 10 |
| S8 | Sr | N/A | N/A | N/A | 5.87 | 10 |
| S9 | LaMn | 11.57 | N/A | 4.78 | N/A | 180 |
| S10 | LaMn | 13.11 | N/A | 5.42 | N/A | 180 |
| S11 | LaMn | 11.57 | N/A | 4.78 | N/A | 10 |
| S12 | LaMn | 13.11 | N/A | 5.42 | N/A | 10 |

* Total volume of solution/suspension was adjusted to match initial pore volume of the porous alumina body

Physical properties for each sample aluminate material S1-S12 were observed, measured and recorded. Table 2 below summarizes the observed and measured physical properties for each sample, including specific surface area, pore volume, median pore diameter and phase presence within the sample.

TABLE 2
Sample Aluminate Material Physical Property Observations and Measurements

| | Predominate Phase | Other Phase | | | Median Pore |
|---|---|---|---|---|---|
| | Presence | Presence | SSA (BET) | Pore Volume | Diameter |
| Sample | (>70 vol. %) | (<30 vol. %) | (m²/g) | (mL/g) | (um) |
| S1 | Hexaaluminate | No Phases | 4.24 | 0.26 | 0.24 |
| | (magnetoplumbite) | Detected | | | |
| S2 | Hexaaluminate | No Phases | 4.51 | 0.27 | 0.23 |
| | (magnetoplumbite) | Detected | | | |
| S3 | No Analysis | No Phases | 9.67 | 0.32 | 0.13 |
| | Performed | Detected | | | |
| S4 | Hexaaluminate | Perovskite | 9.26 | 0.34 | 0.14 |
| | (magnetoplumbite) | | | | |
| S5 | Hexaaluminate | Perovskite, | 4.75 | 0.48 | 0.41 |
| | (magnetoplumbite) | α-alumina | | | |
| S6 | No Analysis | No Analysis | 5.19 | 0.52 | 0.41 |
| | Performed | Performed | | | |
| S7 | Hexaaluminate | Perovskite, | 7.39 | 0.54 | 0.32 |
| | (magnetoplumbite) | α-alumina | | | |
| S8 | Hexaaluminate | Strontium | 7.95 | 0.58 | 0.30 |
| | (magnetoplumbite) | Oxide | | | |
| S9 | Hexaaluminate | α-alumina | 2.65 | 0.30 | 0.39 |
| | (magnetoplumbite) | | | | |
| S10 | No Analysis | No Analysis | 1.86 | 0.26 | 0.36 |
| | Performed | Performed | | | |
| S11 | Hexaaluminate | α-alumina | 5.99 | 0.35 | 0.22 |
| | (magnetoplumbite) | | | | |
| S12 | Hexaaluminate | Perovskite, | 5.09 | 0.35 | 0.21 |
| | (magnetoplumbite) | α-alumina | | | |

As shown in Table 2 above, each sample aluminate material included a hexaaluminate phase formed in-situ during sintering of the sample.

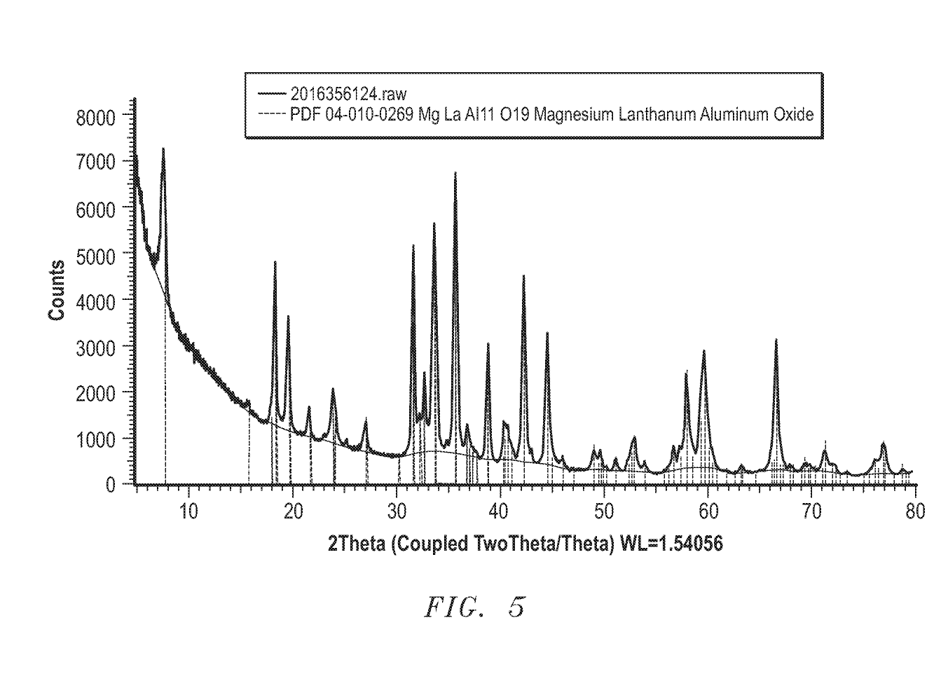

FIG. 5 includes an X-ray powder diffraction (XRD) plot for sample S3. As show in FIG. 5, hexaaluminate phase exists as the major phase in the sample aluminate material S3 with no other crystalline phases existing in detectable amounts.

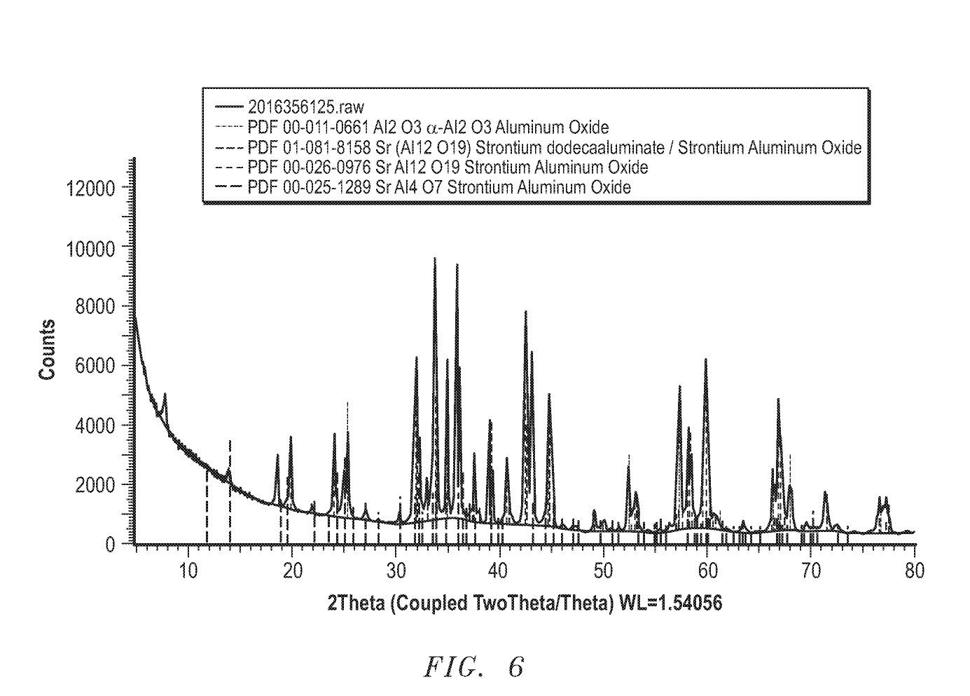

FIG. 6 includes an X-ray powder diffraction (XRD) plot for sample S7. As show in FIG. 6, SrAl₁₂O₁₉ hexaaluminate phase exists as the major phase in sample aluminate material S7 with minor constituents of α-alumina and trace amounts strontium alumina oxide by peak ratio. It should be noted that certain XRD databases notate this hexaaluminate as “SrAl₂O₁₉” while other XRD databases notate this hexaaluminate as “Sr(Al₁₂O₁₉)”. However, the XRD signature is the same regardless of the XRD database notation used.

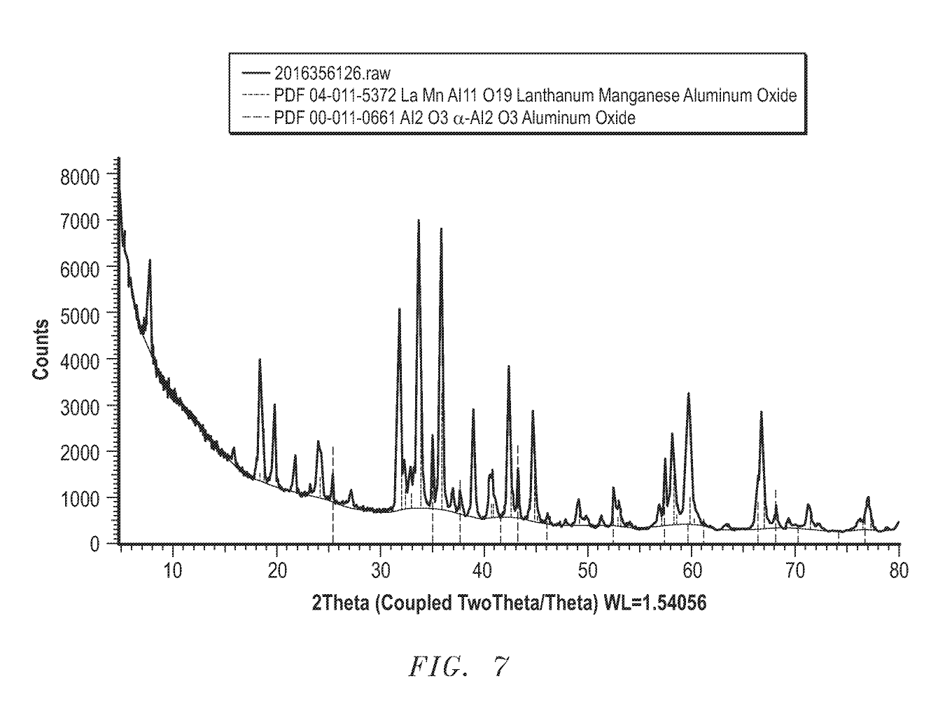

FIG. 7 includes an X-ray powder diffraction (XRD) plot for sample S11. As show in FIG. 7, hexaaluminate phase of LaMnAl₁₁O₁₉ exists as the major phase in sample aluminate material S11 with α-alumina existing as a minor constituent by peak ratio.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Moreover, not all of the activities described above in the general description or the examples are required, that a portion of a specific activity cannot be required, and that one or more further activities can be performed in addition to those described. Still further, the order in which activities are listed is not necessarily the order in which they are performed.

The disclosure is submitted with the understanding that it will not be used to limit the scope or meaning of the claims. In addition, in the foregoing disclosure, certain features that are, for clarity, described herein in the context of separate embodiments, can also be provided in combination in a single embodiment. Conversely, various features that are, for brevity, described in the context of a single embodiment, can also be provided separately or in any subcombination. Still, inventive subject matter can be directed to less than all features of any of the disclosed embodiments.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

Thus, to the maximum extent allowed by law, the scope of the present invention is to be determined by the broadest permissible interpretation of the following claims and their equivalents, and shall not be restricted or limited by the foregoing detailed description.

What is claimed is:

1. A catalyst carrier comprising an aluminate based body, wherein the aluminate comprises a hexaaluminate phase and wherein the catalyst carrier has a specific surface area of not greater than about 20 m²/g.

2. A method of forming a catalyst carrier, wherein the method comprises:
providing an aluminate precursor mixture;
forming the aluminate precursor mixture into a green carrier; and
heating the aluminate precursor mixture to form the catalyst carrier,
wherein the catalyst carrier comprises a hexaaluminate phase, and
wherein formation of the hexaaluminate phase occurs in-situ during heating of the aluminate precursor mixture.

3. The method of claim 2, wherein the aluminate precursor mixture comprises:
boehmite, gamma alumina or combinations thereof; and
at least one aluminate forming component.

4. A method of forming a catalyst carrier, wherein the method comprises:
providing a porous alumina body;
impregnating the porous alumina body with a solution or suspension of at least one aluminate forming component to form an impregnated porous alumina body;
heating the impregnated porous alumina body to form the catalyst carrier,
wherein the catalyst carrier comprises a hexaaluminate phase, and
wherein formation of the hexaaluminate phase occurs in-situ during heating of the impregnated porous alumina body.

5. The catalyst carrier of claim 1, wherein the catalyst carrier comprises a hexaaluminate phase content of at least about 70 vol. % of a total volume of the catalyst carrier.

6. The catalyst carrier of claim 1, wherein the hexaaluminate phase comprises a magnetoplumbite phase, a ß-aluminate phase or combinations thereof.

7. The catalyst carrier of claim 1, wherein the hexaaluminate phase has a formula M₁₋ₓD_{y}LnₓAl₁₂₋ₓO_{19-x+y}, MD_{y}LnₓAl₁₂₋ₓO_{19+y} or MₓD_{y}LnAl₁₁O_{18+x+y},
where M is selected from the group consisting of Ca and Sr,
where D is selected from the group consisting of Mg, Ba, Mn, Fe, Co, Cu, Ni, Zn,
where Ln is selected from the group consisting of praseodymium, samarium, europium, holmium, lanthanum, gadolinium, dysprosium, neodymium, erbium, and mixtures thereof,
where 1≥x≥0, and
where 1≥y≥0.

8. The catalyst carrier of claim 1, wherein the hexaaluminate phase has a formula of LaAl₁₁O₁₈, LaZnAl₁₁O₁₉, LaMgAl₁₁O₁₉, LaSrAl₁O₁₉, LaMnAl₁₁O₁₉, LaFeAl₁₁O₁₉, LaCuAl₁₁O₁₉, LaCoAl₁₁O₁₉, LaNiAl₁₁O₁₉, SrAl₁₂O₁₉, Sr_{0.5}Mn_{0.5}Al₁₂O₁₉, Sr_{0.5}Fe_{0.5}Al₁₂O₁₉, CaAl₁₂O₁₉, Ca_{0.5}Mn_{0.5}Al₁₂O₁₉, Ca_{0.5}Fe_{0.5}Al₁₂O₁₉ and any combination thereof.

9. The catalyst carrier of claim 1, wherein the catalyst carrier comprises a combined content of any oxides of M elements, any oxides of D elements, and any oxides of Ln compounds of at least about 10 vol. % of a total volume of the catalyst carrier, where M is selected from the group consisting of Ca and Sr, where D is selected from the group consisting of Mg, Ba, Mn, Fe, Co, Cu, Ni, Zn, and where Ln is selected from the group consisting of praseodymium, samarium, europium, holmium, lanthanum, gadolinium, dysprosium, neodymium, erbium, and mixtures thereof.

10. The catalyst carrier of claim 1, wherein the catalyst carrier comprises particles in the shape of platelets.

11. The catalyst carrier of claim 1, wherein the platelets comprise an average diameter of at least about 0.1 microns.

12. The catalyst carrier of claim 1, wherein the platelets comprise an average aspect ratio of at least about 2.

13. The method of claim 4, wherein the porous alumina body comprises gamma alumina.

14. The method of claim 4, wherein the porous alumina body comprises a pore volume of at least about 0.5 ml/g and not greater than about 1 ml/g.

15. The method of claim 3, wherein the aluminate forming component comprises soluble salts or fine powders of an alkali earth, Mn, Fe, Co, Cu, Ni, Zn, or a rare earth or combinations thereof.
